(19) United States
(12) Patent Application Publication
(10) Pub. No.: US 2018/0299184 A1
(43) Pub. Date: Oct. 18, 2018

(54) DRIP TRAY FOR A REFRIGERATOR APPLIANCE

(71) Applicant: Haier US Appliance Solutions, Inc., Wilmington, DE (US)

(72) Inventor: Danister Abeygunawardana, Louisville, KY (US)

(21) Appl. No.: 15/489,822

(22) Filed: Apr. 18, 2017

(51) Int. Cl. F25D 21/14; F25D 23/02; F25D 11/02; F25D 23/12; B67D 1/16

(52) U.S. Cl. CPC F25D 21/14; F25D 23/028; F25D 2400/361; F25D 23/126; B67D 1/16; F25D 11/02

(57) ABSTRACT

An appliance includes a drip tray that is removeably mountable within a recess defined by the appliance. The drip tray of the appliance can include features that reduce and/or eliminate wobbling of the drip tray within the recess when the drip tray is mounted therein. Moreover, the drip tray of the appliance can include features that prevent the drip tray from ricocheting off of the recess walls when being slid into or out of the recess, thereby preventing damage to the appliance.

### FIELD OF THE INVENTION

The present subject matter relates generally to refrigerator appliances and more particularly to drip trays for refrigerator appliances.

### BACKGROUND OF THE INVENTION

Certain refrigerator appliances include a dispensing assembly for dispensing liquid and/or ice. Such refrigerator appliances may define a recess in which a user may place a glass or container to receive liquid and/or ice from a dispenser of the dispensing assembly. A drip tray can be mounted within the recess to collect liquid/ice spillage. When mounted within the recess, conventional drip trays often wobble due to one or more gaps between the drip tray and the recess mating surfaces. Moreover, when conventional drip trays are inserted into or removed from the recess, the drip tray may wobble and/or ricochet off the mounting surfaces of the recess. The wobbling and/or ricocheting of the drip tray within the recess can be inconvenient and frustrating to users and can cause damage to the refrigerator appliance.

Accordingly, improved drip trays for refrigerator appliances that address some of these challenges would be useful.

### BRIEF DESCRIPTION OF THE INVENTION

The present disclosure provides an appliance that includes a drip tray that is removeably mountable within a recess defined by the appliance. The drip tray of the appliance can include features that reduce and/or eliminate wobbling of the drip tray within the recess when the drip tray is mounted therein. Moreover, the drip tray of the appliance can include features that prevent the drip tray from ricocheting off of the recess walls when being slid into or out of the recess, thereby preventing damage to the appliance. Additional aspects and advantages of the invention will be set forth in part in the following description, or may be apparent from the description, or may be learned through practice of the invention.

In one exemplary aspect, the present subject matter is directed to a refrigerator appliance. The refrigerator appliance defines a vertical direction, a horizontal direction, and a transverse direction. The refrigerator appliance includes a recess defined by the refrigerator appliance. The recess defines a first mating surface and a second mating surface. The refrigerator appliance further includes a drip tray removeably mountable within the recess. The drip tray includes a body extending along the horizontal direction between a first end and a second end. The drip tray also includes a first spring-loaded plunger positioned at the first end of the body and a second spring-loaded plunger positioned at the second end of the body. When the drip tray is positioned within the recess, the first spring-loaded plunger engages the first mating surface and the second spring-loaded plunger engages the second mating surface such that the first and second spring-loaded plungers exert a force on their respective first and second mating surfaces.

In some exemplary embodiments, the first end of the body has a first sidewall extending along the transverse direction and the second end of the body has a second sidewall extending along the transverse direction. The first spring-loaded plunger is positioned at the first sidewall of the body and the second spring-loaded plunger is positioned at the second sidewall of the body.

In some exemplary embodiments, at least two first spring-loaded plungers are positioned along the first sidewall and at least two second spring-loaded plungers are positioned along the second sidewall.

In some exemplary embodiments, at least three first spring-loaded plungers are positioned along the first sidewall and at least three second spring-loaded plungers are positioned along the second sidewall.

In some exemplary embodiments, the first and second spring-loaded plungers are positioned at their respective first and second ends proximate a rear portion of their respective first and second side walls.

In some exemplary embodiments, the body further includes a first housing and a second housing and wherein the first and second spring-loaded plungers each includes a spring, each spring enclosed within their respective first and second housings.

In some exemplary embodiments, the first and second spring-loaded plungers each include a moveable plunger connected with a spring oriented along the horizontal direction, the plunger of the first spring-loaded plunger engageable with the first mating surface and the plunger of the second spring-loaded plunger engageable with the second mating surface when the drip tray is mounted within recess or otherwise transitioned into or out of recess.

In some exemplary embodiments, the first and second spring-loaded plungers are positioned coaxially with one another along the horizontal direction.

In some exemplary embodiments, the first and second mating surfaces each extend along the transverse direction and substantially parallel with one another, and wherein the first end of the body has a first sidewall extending along the transverse direction and the second end of the body has a second sidewall extending along the transverse direction, and wherein the first spring-loaded plunger is positioned at the first sidewall of the body and the second spring-loaded plunger is positioned at the second sidewall of the body.

In another exemplary aspect, the present subject matter is directed to a refrigerator appliance. The refrigerator appliance defines a vertical direction, a horizontal direction, and a transverse direction. The refrigerator appliance includes a recess defined by the refrigerator appliance. The recess defines a first mating surface and a second mating surface. The refrigerator appliance further includes a drip tray removeably mountable within the recess. The drip tray includes a body extending along the horizontal direction between a first end and a second end. The drip tray further includes a first spring-loaded plunger positioned at the first end of the body, the first spring-loaded plunger includes a plunger connected with a spring having a length, the length of the spring oriented substantially along the horizontal direction. The drip tray also includes a second spring-loaded plunger positioned at the second end of the body, the second spring-loaded plunger includes a plunger connected with a spring having a length, the length of the spring oriented substantially along the horizontal direction. The first spring-loaded plunger is positioned substantially coaxially with the second spring-loaded plunger. When the drip tray is positioned within the recess, the plunger of the first spring-loaded plunger engages the first mating surface and the plunger of the second spring-loaded plunger engages the second mating surface such that the first and second spring-loaded plungers exert a force on their respective first and second mating surfaces.

In some exemplary embodiments, the refrigerator appliance includes a cabinet and one or more refrigerator doors rotatably mounted with the cabinet. The recess is defined by one of the refrigerator doors.

In some exemplary embodiments, the first end of the body has a first sidewall extending along the transverse direction and the second end of the body has a second sidewall extending along the transverse direction, and wherein the first spring-loaded plunger is positioned at the first sidewall of the body and the second spring-loaded plunger is positioned at the second sidewall of the body, and wherein the first sidewall and the second sidewall are substantially parallel to one another.

In some exemplary embodiments, at least two first spring-loaded plungers are positioned along the first sidewall and at least two second spring-loaded plungers are positioned along the second sidewall.

In some exemplary embodiments, each first spring-loaded plunger is positioned coaxially with one of the second spring-loaded plungers.

In some exemplary embodiments, the body of the drip tray extends along the transverse direction between a front and a rear and wherein the first end of the body has a first sidewall extending along the transverse direction and the second end of the body has a second sidewall extending along the transverse direction, and wherein the first spring-loaded plunger is positioned at the first sidewall of the body and the second spring-loaded plunger is positioned at the second sidewall of the body, and wherein the first sidewall and the second sidewall are substantially parallel to one another, and wherein the first and second spring-loaded plungers are positioned proximate a rear portion of their respective first and second sidewalls, wherein the rear portion is approximately the first and last place the first and second sidewalls contact their respective first and second mating surfaces as the drip tray is inserted into or removed from the recess.

In some exemplary embodiments, the body further includes a first housing and a second housing and wherein the springs of the first and second spring-loaded plungers are each enclosed within their respective first and second housings.

In some exemplary embodiments, the first and second mating surfaces are substantially parallel with one another along the transverse direction, and wherein the first end of the body has a first sidewall extending along the transverse direction and the second end of the body has a second sidewall extending along the transverse direction, and wherein the first spring-loaded plunger is positioned at the first sidewall of the body and the second spring-loaded plunger is positioned at the second sidewall of the body, and wherein when the drip tray is mounted within recess or otherwise transitioned into or out of recess, the first spring-loaded plunger is in mating engagement with the first mating surface and the second spring-loaded plunger is in mating engagement with the second mating surface.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to exemplary embodiments of the present subject matter;

FIG. 2 provides a front view of a dispensing assembly of the refrigerator appliance of FIG. 1 according to exemplary embodiments of the present subject matter;

FIG. 3 provides a perspective view of the dispensing assembly of the refrigerator appliance of FIG. 1 according to exemplary embodiments of the present subject matter;

FIG. 4 provides a rear, perspective view of an exemplary drip tray according to exemplary embodiments of the present subject matter;

FIG. 5 provides a perspective, cross sectional view of an exemplary spring-loaded plunger according to exemplary embodiments of the present subject matter;

FIG. 6 provides a side, perspective view of an exemplary drip tray according to exemplary embodiments of the present subject matter;

FIG. 7 provides a side, perspective view of another exemplary drip tray according to exemplary embodiments of the present subject matter;

FIG. 8 provides a top view of an exemplary drip tray mounted within a recess according to exemplary embodiments of the present subject matter; and

FIG. 9 provides a close up view of Section A of FIG. 8 illustrating an exemplary spring-loaded plunger engaging a mating surface of the recess.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

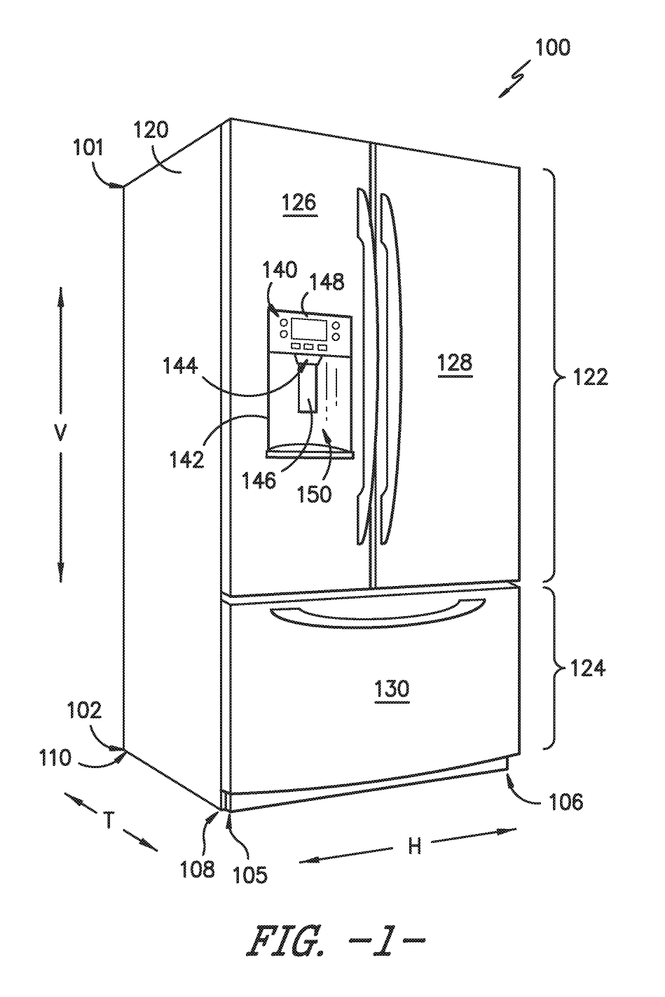

FIG. 1 provides a perspective view of a refrigerator appliance 100 according to exemplary embodiments of the present subject matter. Refrigerator appliance 100 includes a housing or cabinet 120 that extends between a top 101 and a bottom 102 along a vertical direction V. Cabinet 120 also extends between a first side 105 and a second side 106 along a horizontal direction H and between a front 108 and a rear 110 along a transverse direction T. Vertical direction V, horizontal direction H, and transverse direction T are mutually perpendicular and form an orthogonal direction system.

Cabinet 120 defines chilled chambers for receipt of food items for storage. In particular, cabinet 120 defines a fresh food chamber 122 positioned at or adjacent top 101 of cabinet 120 and a freezer chamber 124 arranged at or adjacent bottom 102 of cabinet 120. As such, refrigerator appliance 100 is generally referred to as a bottom mount refrigerator. It is recognized, however, that the benefits of the present subject matter apply to other types and styles of refrigerator appliances such as, e.g., a top mount refrigerator appliance or a side-by-side style refrigerator appliance. Moreover, the benefits of the present subject matter may likewise apply to freezer appliances, e.g., upright freezers, or any other appliance having a liquid/ice dispenser. Consequently, the description set forth herein is for exemplary purposes only and is not intended to be limiting in any aspect to any particular refrigerator or freezer chamber configuration.

Refrigerator doors 126, 128 are rotatably hinged to an edge of cabinet 120 for selectively accessing fresh food chamber 122. In addition, a freezer door 130 is arranged below refrigerator doors 126, 128 for selectively accessing freezer chamber 124. Refrigerator doors 126, 128 and freezer door 130 are shown in a closed configuration in FIG. 1.

Refrigerator appliance 100 includes a dispensing assembly 140 for dispensing liquid and/or ice. Dispensing assembly 140 includes a dispenser 142 positioned on or mounted to an exterior portion of refrigerator appliance 100, e.g., on one of doors 126, 128. Dispenser 142 defines a discharging outlet 144 in which liquid and/or ice may exit dispenser 142. An actuating mechanism 146, shown as a paddle in FIG. 1, is mounted below discharging outlet 144 for operating dispenser 142. In alternative exemplary embodiments, any suitable actuating mechanism may be used to operate dispenser 142. For example, dispenser 142 can include a sensor (such as an ultrasonic sensor) or a button rather than the paddle.

Dispensing assembly 140 is located within a recess 150 defined by refrigerator appliance 100. More particularly, recess 150 is defined by refrigerator door 126 for this embodiment. Recess 150 is positioned at an elevation convenient for users to access ice or liquid from dispenser 142 without need to bend over or open doors 126, 128. In the exemplary embodiment of FIG. 1, recess 150 is positioned at a level that approximates the chest level of an adult user.

A user interface panel 148 is provided for controlling a mode of operation of dispenser 142 and other systems of refrigerator appliance 100. For example, user interface panel 148 includes a plurality of user inputs (not labeled), such as a water dispensing button and an ice-dispensing button, for selecting a desired mode of operation, such as crushed or non-crushed ice. In one embodiment, user interface panel 148 may include input components, such as one or more of a variety of electrical, mechanical or electro-mechanical input devices including rotary dials, push buttons, and touch pads. User interface panel 148 may include a display component, such as a digital or analog display device designed to provide operational feedback to users.

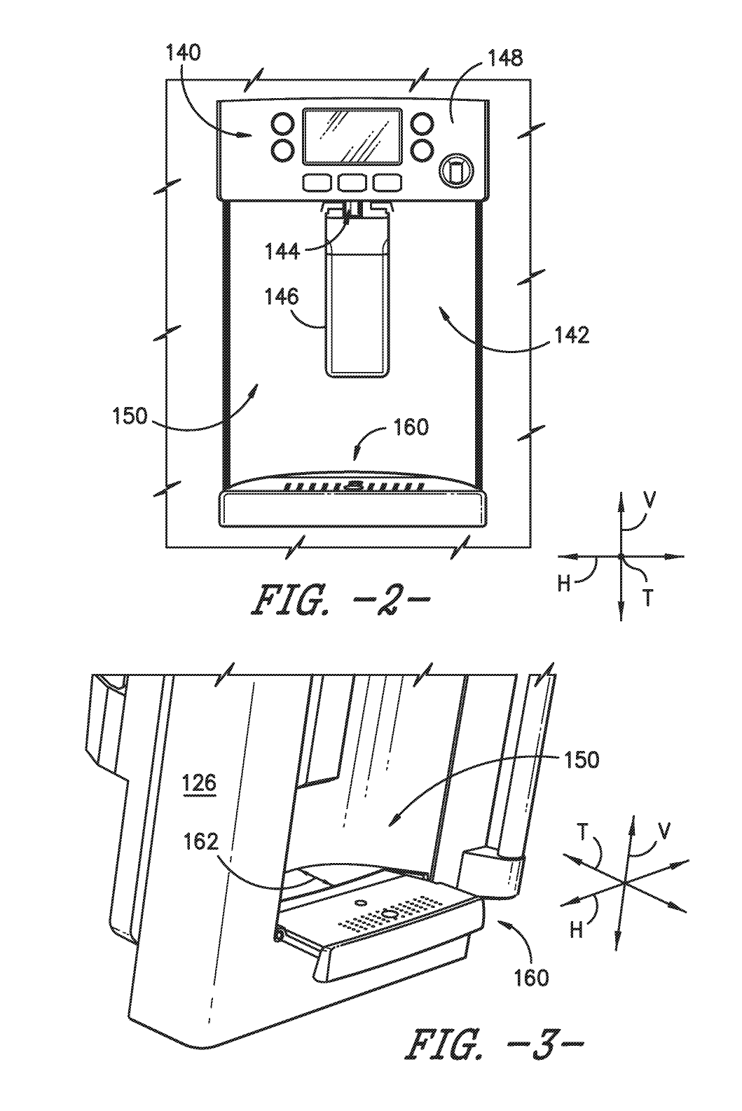

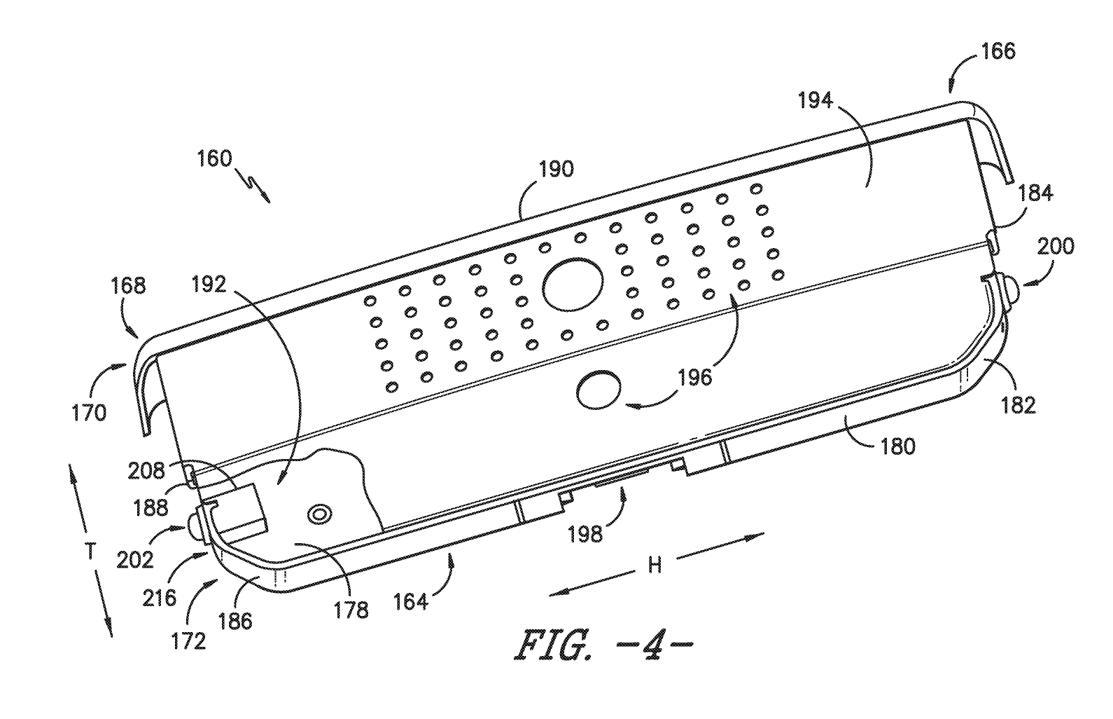

With reference to FIGS. 2 and 3, FIG. 2 provides a front view of dispensing assembly 140 of exemplary refrigerator appliance 100 of FIG. 1 and FIG. 3 provides a perspective view of dispensing assembly 140 of exemplary refrigerator appliance 100 of FIG. 1 according to exemplary embodiments of the present subject matter. In FIG. 2, a drip tray 160 is shown mounted within recess 150 for collecting liquid/ice spillage that may result when a user operates dispenser 142. Drip tray 160 is removeably mounted within recess 150. In particular, drip tray 160 is shown being slideably inserted within recess 150 in FIG. 3. Drip tray 160 can also be slideably removed from recess 150. In this way, drip tray 160 is translatable along the transverse direction T, as denoted by arrow 162.

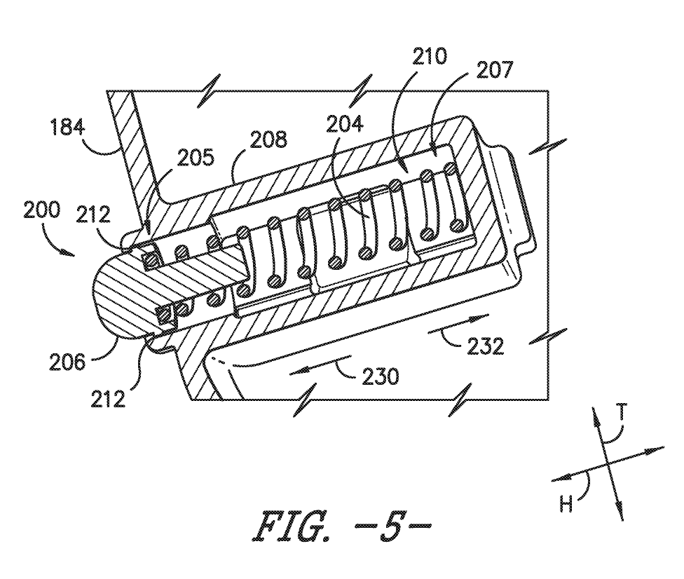

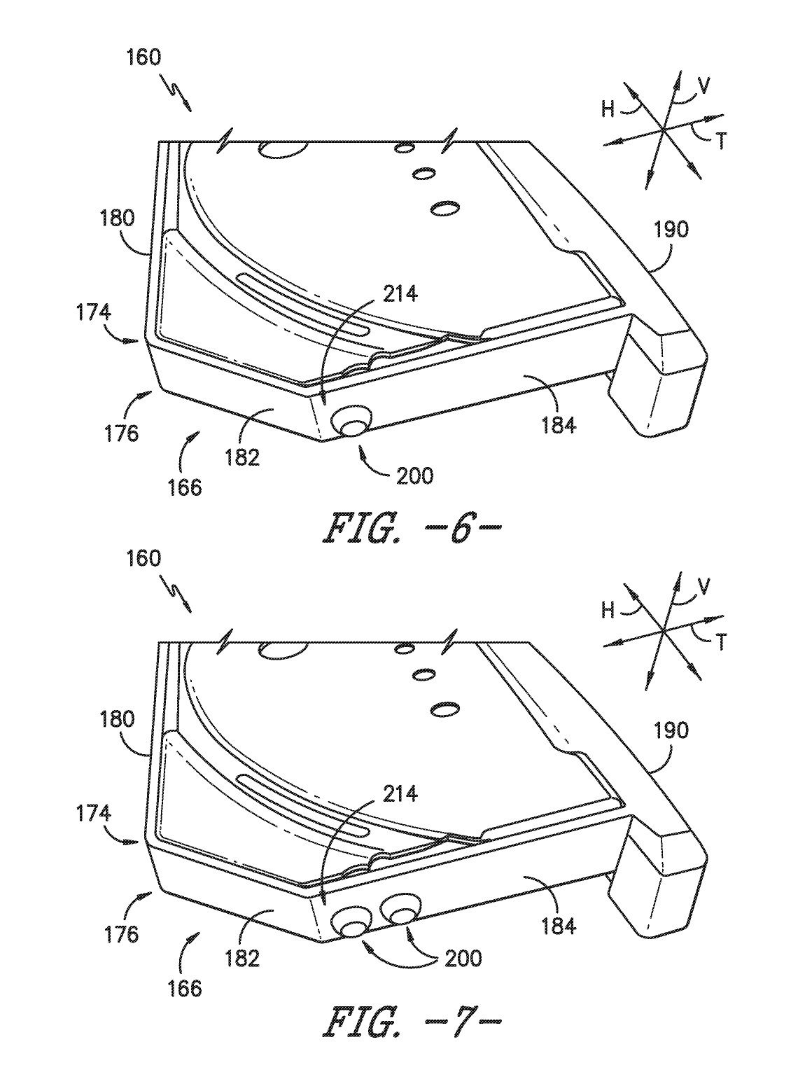

FIG. 4 provides a rear, perspective view of drip tray 160 according to exemplary embodiments of the present subject matter. Drip tray 160 includes a sump or body 164. Generally, body 164 extends along the horizontal direction H between a first end 166 and a second end 168 and along the transverse direction T between a front 170 and a rear 172. Body 164 also extends along the vertical direction V between a top 174 and a bottom 176 (FIG. 6).

Body 164 includes a bottom wall 178 extending through a plane that is parallel to the horizontal direction H and the transverse direction T. A number of sidewalls are integral or attached to bottom wall 178 and extend generally in the vertical direction V. The sidewalls include a rear sidewall 180 extending generally along the horizontal direction H at rear 172 of body 164. Connected or integral with rear sidewall 180 at first end 166 of body 164 is a first transition wall 182. First transition wall 182 transitions horizontally oriented rear sidewall 180 into a first sidewall 184 that extends along the transverse direction T. In a similar fashion, connected or integral with rear sidewall 180 at second end 168 of body 164 is a second transition wall 186. Second transition wall 186 transitions horizontally oriented rear sidewall 180 into a second sidewall 188 that extends along the transverse direction T. Second sidewall 188 is substantially parallel with first sidewall 184. A front sidewall 190 connects first sidewall 184 with second sidewall and generally extends along the horizontal direction H at front 170 of body 164 (FIG. 6).

A plate or collar 194 is positioned at or adjacent top 174 and is attached to or integral with body 164. Collar 194 generally extends in a plane parallel to the horizontal direction H and the transverse direction T in a shape complementary to body 164 as shown. In this way, a user may set a glass or container level onto collar 194 such that dispenser 142 can dispense liquid and/or ice into the user's glass or container. As shown by the cutaway of collar 194 in FIG. 4, bottom wall 178 and the sidewalls that form body 164 collectively define a drip tray recess 192 in which liquid and/or ice spilled during operation of dispenser 142 can be collected or stored. Collar 194 defines a plurality of apertures 196 that provide a means for liquid and/or ice spillage to be collected into drip tray recess 192.

Body 164 further includes a latch 198 that operatively connects or couples drip tray 160 with refrigerator appliance 100 when it is mounted thereto. To secure drip tray 160 within recess 150, a user can insert drip tray 160 into recess 150 and latch 198 can be configured to make a blind connection with one or more mating parts or components of refrigerator appliance 100 located within recess 150. To remove drip tray 160 from recess 150, a user can manipulate latch 198 to release drip tray 160.

Referring still to FIG. 4, drip tray 160 also includes one or more spring-loaded plungers. For this embodiment, a first spring-loaded plunger 200 is positioned at first end 166 of body 164 and a second spring-loaded plunger 202 is positioned at second end 168 of body 164. More particularly, first spring-loaded plunger 200 is positioned at first sidewall 184 of body 164 and second spring-loaded plunger 202 is positioned at second sidewall 188 of body 164. As shown, first spring-loaded plunger 200 is positioned coaxially with second spring-loaded plunger 202 along the horizontal direction H. Coaxial positioning of first spring-loaded plunger 200 and second spring-loaded plunger 202 may assist a user in aligning drip tray 160 with recess 150 and with sliding drip tray 160 into and out of recess 150. In some embodiments, however, first spring-loaded plunger 200 need not be coaxially positioned with second spring-loaded plunger 202 along the horizontal direction H.

FIG. 5 provides a perspective, cross sectional view of an exemplary spring-loaded plunger according to exemplary embodiments of the present subject matter. Specifically, in FIG. 5, first spring-loaded plunger 200 is shown. First spring-loaded plunger 200 includes a spring 204 having a first end 205 and a second end 207. First spring-loaded plunger 200 also includes a ball or plunger 206 connected with spring 204 at its first end 205. Plunger 206 can be any suitable shape. Spring 204 and plunger 206 are enclosed within a housing 208 that can be formed integral with or attached to first sidewall 184. As shown, spring 204 and at least a portion of plunger 206 are positioned within a chamber 210 defined by housing 208. Spring 204 contacts or sits relatively flush with housing 208 at its second end 207. Housing 208 includes one or more stops 212 that prevent plunger 206 from extending too far outward in the horizontal direction H. It will be appreciated that second spring-loaded plunger 202 or other spring-loaded plungers can include and be oriented in the same or similar manner as that described for first spring-loaded plunger 200.

For this embodiment, plunger 206 is moveable along the horizontal direction H. When spring 204 is in a relaxed state (shown in FIG. 5), plunger 206 extends further horizontally outward, denoted by arrow 230, in the horizontal direction H than first sidewall 184. When a force is applied to plunger 206, such as e.g., a mating surface of recess 150, plunger 206 is pushed horizontally inward, denoted by arrow 232, causing spring 204 to compress. When compressed, spring 204 and plunger 206 connected thereto in turn exert a horizontally outward force as spring 204 seeks to return to its relaxed state.

FIG. 6 provides a side, perspective view of an exemplary drip tray 160 according to exemplary embodiments of the present subject matter. For this embodiment, drip tray 160 includes first spring-loaded plunger 200 positioned at first end 166 and second spring-loaded plunger positioned at second end 168 (second end 168 is not shown in FIG. 6). More particularly, first spring-loaded plunger 200 is positioned at first sidewall 184 and second spring-loaded plunger 202 is positioned at second sidewall 188.

Moreover, as shown in FIG. 6, at least one first spring-loaded plunger 200 is positioned proximate a first rear portion 214 of first sidewall 184. Additionally, at least one second spring-loaded plunger 202 is positioned proximate a second rear portion 216 of second sidewall 188 (see FIG. 4). The first and second rear portions 214, 216 are portions of their respective first and second sidewalls 184, 186 that are the first portions of the sidewalls 184, 188 to come into contact with the mating surfaces of recess 150 when drip tray 160 is inserted into recess 150 and the last portions of the sidewalls 184, 188 to touch the mating surfaces of recess 150 when drip tray 160 is removed from recess 150. By positioning at least one first spring-loaded plunger 200 and one second spring-loaded plunger 202 proximate their respective first and second rear portions 214, 216, a user can immediately orient and correctly position drip tray 160 into recess 150 when inserting drip tray 160 therein and can prevent drip tray 160 from ricocheting off of the surfaces of recess 150 when removing drip tray 160 from recess 150, thereby preventing damage to the surfaces of recess 150.

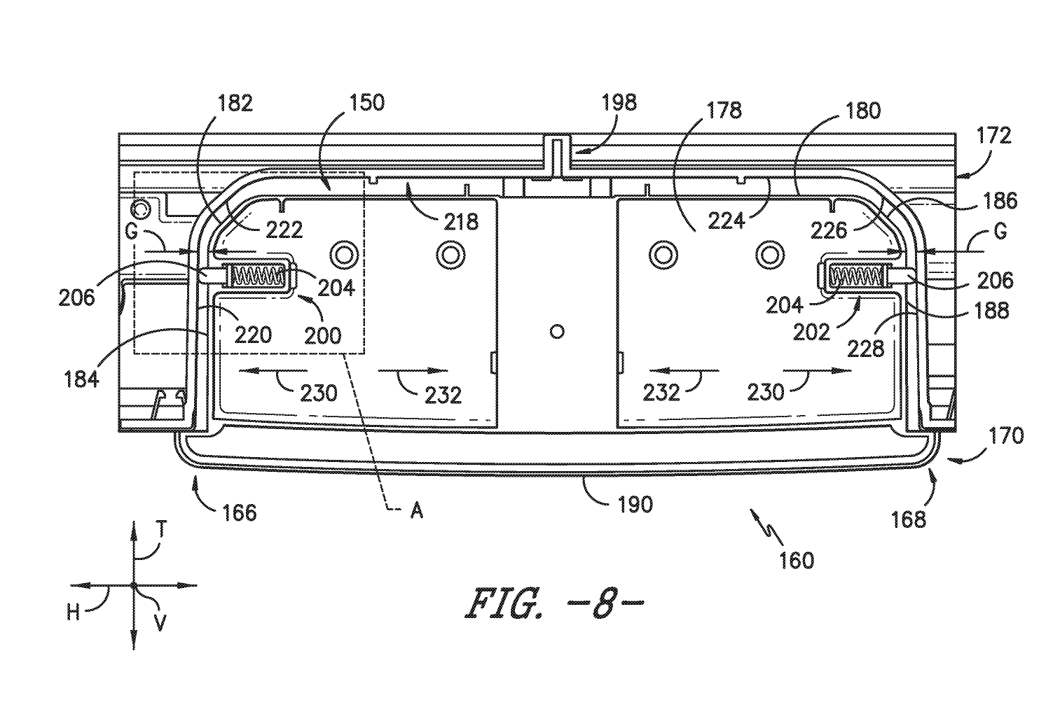

FIG. 7 provides a side, perspective view of another exemplary drip tray 160 according to exemplary embodiments of the present subject matter. For this embodiment, drip tray 160 includes multiple spring-loaded plungers at both first end 166 and second end 168 (second end 168 is not shown in FIG. 7). More particularly, first sidewall 184 includes two first spring-loaded plungers 200 and second sidewall 188 includes two second spring-loaded plungers 202. First spring-loaded plungers 200 are positioned proximate one another. However, first spring-loaded plungers 200 need not be positioned proximate one another. For example, first sidewall 184 can include one first spring-loaded plunger 200 at its rear portion, one first spring-loaded plunger 200 at its front portion, and one first spring-loaded plunger 200 positioned approximately midway between the other two first spring-loaded plungers 200. Second sidewall 188 can include a similar configuration with second spring-loaded plungers 202. Other orientations and configurations of spring-loaded plungers positioned along the first and second sidewalls 184, 188 are contemplated. It will be appreciated that drip tray 160 can include any suitable number of first and/or second spring-loaded plungers 200, 202. By positioning multiple spring-loaded plungers along first sidewall 184 and second sidewall 188 of drip tray 160, a user may have more sliding control over drip tray 160 when drip tray 160 is slid into or out of recess 150. In this way, a user is less likely to bounce or ricochet drip tray 160 off of the surfaces of recess 150 when drip tray 160 is slid into or out of recess 150. In addition, multiple spring-loaded plungers along first sidewall 184 and second sidewall 188 of drip tray 160 may also further prevent or eliminate wobbling when drip tray 160 is fully mounted within recess 150.

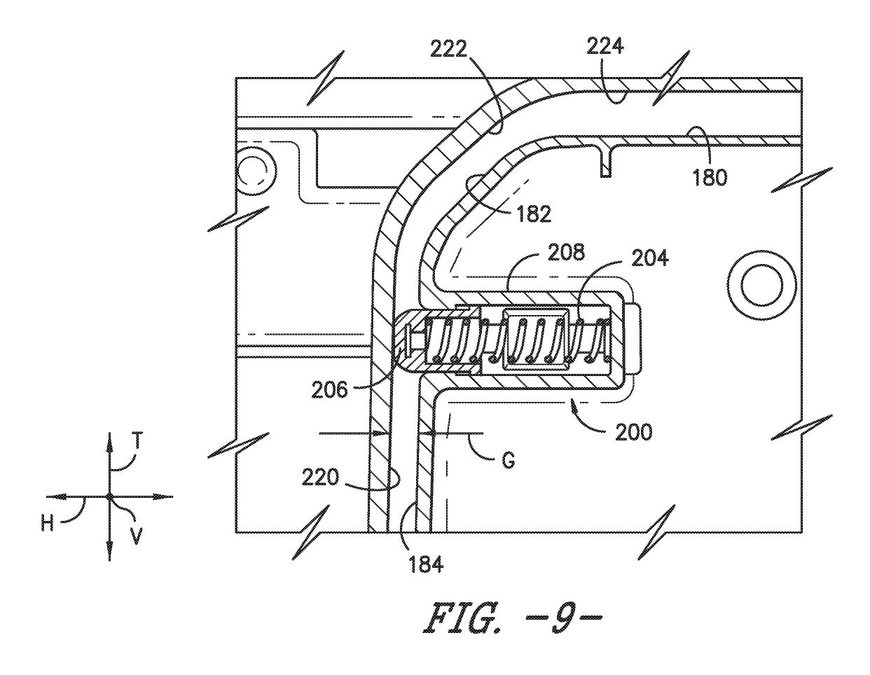

FIG. 8 provides a top view of drip tray 160 mounted within recess 150 and FIG. 9 provides a close up cross sectional view of Section A of FIG. 8 illustrating an exemplary spring-loaded plunger engaging a mating surface 218 of recess 150 according to exemplary embodiments of the present subject matter. In FIGS. 8 and 9, collar 194 has been removed for clarity and the top walls of housings 208 have been removed such that first and second spring-loaded plungers 200, 202 can be viewed more clearly.

As shown, recess 150 defines mating surface 218. Generally, mating surface 218 provides a mating interface in which one or more spring-loaded plungers may engage. Stated alternatively, first spring-loaded plunger 200 and second spring-loaded plunger 202 (as well as other spring-loaded plungers drip tray 160 may include) are engageable with mating surface 218. Mating surface 218 extends generally in the vertical direction V to provide the mounting interface for the first and second spring-loaded plungers 200, 202 to engage thereto. Moreover, mating surface 218 extends in a shape complementary to the sidewalls of drip tray 160. In this way, drip tray 160 is shaped complementary to recess 150 such that drip tray 160 can be readily mounted therein.

Mating surface 218 includes a first mating surface 220 extending along the transverse direction T. When drip tray 160 is mounted or being transitioned into or out of recess 150, first mating surface 220 is engageable by one or more first spring-loaded plungers 200. When drip tray 160 is inserted within recess 150, first sidewall 184 of drip tray 160 is oriented substantially parallel with first mating surface 220 of refrigerator appliance 100. Mating surface 218 further includes a first transition surface 222 that transitions first mating surface 220 extending along the transverse direction T with a rear surface 224 that extends generally along the horizontal direction H. When drip tray 160 is mounted within recess 150, as shown in FIG. 8, rear sidewall 180 of drip tray 160 is positioned substantially parallel with rear surface 224 of refrigerator appliance 100. Rear surface 224 includes one or more mechanisms (not labeled) for latch 198 to be connected to or with refrigerator appliance 100 when drip tray 160 is mounted within recess 150. A second transition surface 226 transitions horizontally extending rear surface 224 to a second mating surface 228 extending along the transverse direction T. When drip tray 160 is mounted or being transitioned into or out of recess 150, second mating surface 228 is engageable by one or more second spring-loaded plungers 202. When drip tray 160 is inserted within recess 150, second sidewall 188 of drip tray 160 is oriented substantially parallel with second mating surface 228 of refrigerator appliance 100. For this embodiment, first mating surface 220 is substantially parallel with second mating surface 228. In some embodiments, however, first mating surface 220 and second mating surface 228 need not be substantially parallel with one another.

As noted previously, drip tray 160 is mounted within recess 150 and secured to refrigerator appliance 100 by latch 198. However, as shown, when drip tray 160 is mounted or inserted within recess 150, a gap G is defined between at least one of first end 166 of body 164 and first mating surface 220 and second end 168 of body 164 and second mating surface 228. For this embodiment, there is a gap G between first sidewall 184 of drip tray 160 and first mating surface 220 of refrigerator appliance 100 and there is a gap G between second sidewall 188 of drip tray 160 and second mating surface 228 of refrigerator appliance 100.

First spring-loaded plunger 200 and second spring-loaded plunger 202 generally extend along the horizontal direction H and extend horizontally outward, as denoted by arrows 230, past their respective first and second sidewalls 184, 188 when their respective springs 204 are in a relaxed state. When drip tray 160 is mounted within recess 150 or otherwise transitioned to or from recess 150, the plungers 206 of first spring-loaded plunger 200 and second spring-loaded plunger 202 are pushed horizontally inward as denoted by arrows 232 when first and second spring-loaded plungers 200, 202 engage their respective first and second mating surfaces 220, 228. For this embodiment, first spring-loaded plunger 200 positioned at first sidewall 184 engages first mating surface 220 and second spring-loaded plunger 202 positioned at second sidewall 188 engages second mating surface 228. Springs 204, now in a compressed state, apply horizontally outward forces on their respective plungers 206 such that first and second spring-loaded plungers 200, 202 span the gaps G and are in mating engagement with their respective first and second mating surfaces 220, 228 as shown in FIG. 8 and detailed in FIG. 9. In this way, wobbling of drip tray 160 is reduced or eliminated. Wobbling can be translational and/or rotational movement along the horizontal direction H, transverse direction T, and/or vertical direction V.

When drip tray 160 is slid into or out of recess 150 (i.e., transitioned to or from recess 150), first spring-loaded plunger 200 and second spring-loaded plunger 202 both engage their respective mating surfaces 220, 228, thereby creating a small amount of friction between the first and second spring-loaded plungers 200, 202 and their respective first and second mating surfaces 220, 228. The mating engagement of first spring-loaded plunger 200 with first mating surface 220 and the mating engagement of second spring-loaded plunger 202 with second mating surface 228 provides a smooth sliding effect for a user when drip tray 160 is transitioned into or out of recess 150. Consequently, when drip tray 160 is transitioned into or out of recess 150, wobbling of drip tray 160 and/or the ricocheting of drip tray 160 against mating surface 218 is reduced or eliminated. In this way, drip tray 160 does not damage the surfaces of refrigerator appliance 100.

It will also be appreciated, although not shown, that drip tray 160 can include one or more spring-loaded plungers positioned along rear sidewall 180 of drip tray 160. For example, one spring-loaded plunger can be positioned at rear sidewall 180 along the first end 166 of drip tray 160 and one spring-loaded plunger can be positioned at rear sidewall 180 along second end 168 of drip tray 160. In this manner, the spring-loaded plungers can prevent a user from slamming or hitting rear sidewall 180 of drip tray 160 against rear surface 224 of recess 150. In such embodiments, the spring-loaded plungers are oriented along the transverse direction T.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A refrigerator appliance defining a vertical direction, a horizontal direction, and a transverse direction, the refrigerator appliance comprising:
a recess defined by the refrigerator appliance, the recess defining a first mating surface and a second mating surface;
a drip tray removably mountable within the recess, the drip tray comprising:
a body extending along the horizontal direction between a first end and a second end;
a first spring-loaded plunger positioned at the first end of the body and extending outward from the first end along the horizontal direction; and
a second spring-loaded plunger positioned at the second end of the body and extending outward from the second end along the horizontal direction;
wherein when the drip tray is positioned within the recess, the first spring-loaded plunger engages the first mating surface and the second spring-loaded plunger engages the second mating surface such that the first and second spring-loaded plungers exert a force on the first and second mating surfaces, respectively.

2. The drip tray of claim 1, wherein the first end of the body has a first sidewall extending along the transverse direction and the second end of the body has a second sidewall extending along the transverse direction, and wherein the first spring-loaded plunger is positioned at the first sidewall of the body and the second spring-loaded plunger is positioned at the second sidewall of the body.

3. The drip tray of claim 2, further comprising:
a first, forward spring-loaded plunger positioned at the first end of the body; and
a second, forward spring-loaded plunger positioned at the second end of the body;
wherein the first spring-loaded plunger and the first, forward spring-loaded plunger are positioned along the first sidewall and the second spring-loaded plunger and the second, forward spring-loaded plunger are positioned along the second sidewall.

4. The drip tray of claim 2, wherein the first and second spring-loaded plungers are positioned at the first and second ends, respectively, proximate a rear portion of the first and second sidewalls, respectively.

5. The drip tray of claim 1, wherein the body further includes a first housing and a second housing and wherein the first and second spring-loaded plungers each comprise a spring, each spring enclosed within the first and second housings, respectively.

6. The drip tray of claim 1, wherein the first and second spring-loaded plungers each include a moveable plunger connected with a spring oriented along the horizontal direction, the plunger of the first spring-loaded plunger engageable with the first mating surface and the plunger of the second spring-loaded plunger engageable with the second mating surface when the drip tray is mounted within the recess or otherwise transitioned into or out of the recess.

7. The drip tray of claim 1, wherein the first and second spring-loaded plungers are positioned coaxially with one another along the horizontal direction.

8. The drip tray of claim 1, wherein the first and second mating surfaces each extend along the transverse direction and substantially parallel with one another, and wherein the first end of the body has a first sidewall extending along the transverse direction and the second end of the body has a second sidewall extending along the transverse direction, and wherein the first spring-loaded plunger is positioned at the first sidewall of the body and the second spring-loaded plunger is positioned at the second sidewall of the body.

9. A refrigerator appliance defining a vertical direction, a horizontal direction, and a transverse direction, the refrigerator appliance comprising:
a recess defined by the refrigerator appliance, the recess defining a first mating surface and a second mating surface;
a drip tray removably mountable within the recess, the drip tray comprising:
a body extending along the horizontal direction between a first end and a second end;
a first spring-loaded plunger positioned at the first end of the body and extending outward from the first end of the body along the horizontal direction, the first spring-loaded plunger comprising a plunger connected with a spring having a length, the length of the spring oriented substantially along the horizontal direction; and
a second spring-loaded plunger positioned at the second end of the body and extending outward from the second end of the body along the horizontal direction, the second spring-loaded plunger comprising a plunger connected with a spring having a length, the length of the spring oriented substantially along the horizontal direction, and wherein the first spring-loaded plunger is positioned substantially coaxially with the second spring-loaded plunger;
wherein when the drip tray is positioned within the recess, the plunger of the first spring-loaded plunger engages the first mating surface and the plunger of the second spring-loaded plunger engages the second mating surface such that the first and second spring-loaded plungers exert a force on the first and second mating surfaces, respectively.

10. The refrigerator appliance of claim 9, further comprising:
a cabinet;
one or more refrigerator doors rotatably mounted with the cabinet, and wherein the recess is defined by one of the one or more refrigerator doors.

11. The refrigerator appliance of claim 9, wherein the first end of the body has a first sidewall extending along the transverse direction and the second end of the body has a second sidewall extending along the transverse direction, and wherein the first spring-loaded plunger is positioned at the first sidewall of the body and the second spring-loaded plunger is positioned at the second sidewall of the body, and wherein the first sidewall and the second sidewall are substantially parallel to one another.

12. The refrigerator appliance of claim 11, further comprising:
a first, forward spring-loaded plunger positioned at the first end of the body; and
a second, forward spring-loaded plunger positioned at the second end of the body;
wherein the first spring-loaded plunger and the first, forward spring-loaded plunger are positioned along the first sidewall and the second spring-loaded plunger and the second, forward spring-loaded plunger are positioned along the second sidewall.

13. The refrigerator appliance of claim 12, wherein the first spring-loaded plunger is positioned coaxially with the second spring-loaded plunger and the first, forward spring-loaded plunger is positioned coaxially with the second, forward spring-loaded plunger.

14. (canceled)

15. The refrigerator appliance of claim 9, wherein the body further includes a first housing and a second housing and wherein the springs of the first and second spring-loaded plungers are each enclosed within the first and second housings, respectively.

16. The refrigerator appliance of claim 9, wherein the first and second mating surfaces are substantially parallel with one another along the transverse direction, and wherein the first end of the body has a first sidewall extending along the transverse direction and the second end of the body has a second sidewall extending along the transverse direction, and wherein the first spring-loaded plunger is positioned at the first sidewall of the body and the second spring-loaded plunger is positioned at the second sidewall of the body, and wherein when the drip tray is mounted within the recess or otherwise transitioned into or out of the recess, the first spring-loaded plunger is in mating engagement with the first mating surface and the second spring-loaded plunger is in mating engagement with the second mating surface.

17. A refrigerator appliance defining a vertical direction, a horizontal direction, and a transverse direction, the refrigerator appliance comprising:
a recess defined by the refrigerator appliance, the recess defining a first mating surface and a second mating surface;
a drip tray removably mountable within the recess, the drip tray comprising:
a body extending along the horizontal direction between a first end and a second end, the body having a first sidewall at the first end and a second sidewall at the second end;
a first spring-loaded plunger extending outward from the first sidewall of the body along the horizontal direction, the first spring-loaded plunger comprising a plunger connected with a spring having a length, the length of the spring oriented substantially along the horizontal direction, and wherein the plunger is positioned outward of the spring along the horizontal direction; and
a second spring-loaded plunger positioned at the second end of the body and extending outward from the second sidewall of the body along the horizontal direction, the second spring-loaded plunger comprising a plunger connected with a spring having a length, the length of the spring oriented substantially along the horizontal direction, and wherein the plunger of the second spring-loaded plunger is positioned outward of the spring of the second spring-loaded plunger along the horizontal direction;
wherein when the drip tray is positioned within the recess, the plunger of the first spring-loaded plunger engages the first mating surface and the plunger of the second spring-loaded plunger engages the second mating surface such that the first and second spring-loaded plungers exert a force on the first and second mating surfaces, respectively.

18. The refrigerator appliance of claim 17, wherein the spring of the first spring-loaded plunger extends between a first end and a second end along the horizontal direction, the first end being positioned outward of the second end along the horizontal direction, and wherein the plunger of the first spring-loaded plunger is connected with the first end of the spring of the first spring-loaded plunger and wherein the spring of the second spring-loaded plunger extends between a first end and a second end along the horizontal direction, the first end of the second spring-loaded plunger being positioned outward of the second end of the second spring-loaded plunger along the horizontal direction, and wherein the plunger of the second spring-loaded plunger is connected with the first end of the spring of the second spring-loaded plunger.

19. The refrigerator appliance of claim 17, wherein when the drip tray is mounted within the recess, the plunger of the first spring-loaded plunger is moved inward along the horizontal direction and the plunger of the second spring-loaded plunger is moved inward along the horizontal direction.
